(19) United States
(12) Patent Application Publication
(10) Pub. No.: US 2008/0278320 A1
(43) Pub. Date: Nov. 13, 2008

(54) Method and system for reduction of electronic article surveillance system false alarms

(75) Inventors: Manuel A. Soto, Lake Worth, FL (US); Adam S. Bergman, Boca Raton, FL (US); John A. Allen, Pompano Beach, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Sensormatic Electronics Corporation

(21) Appl. No.: 11/800,690

(22) Filed: May 7, 2007

(51) Int. Cl. G08B 13/00; G08C 19/00

(52) U.S. Cl. 340/541; 340/5.1

(57) ABSTRACT

A method and system for generating alarms in a security system that include establishing a detection region, detecting a first event where the first event is one of (a) detecting a tag in the detection region and (b) detecting a person in the detection region, starting a timer upon detecting the first event, detecting a second event where the second event is the other one of (a) detecting a tag in the detection region and (b) detecting a person in the detection region and enabling an alarm output when the second event is detected prior to expiration of the timer. The method and system for generating alarms in a security system can further include setting a first event flag upon detecting the first event where the first event flag corresponds to the first event and setting a second event flag upon detecting the second event where the second event flag corresponds to the second event.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention generally relates to electronic security systems, and in particular, to an improved electronic article surveillance (“EAS”) system and method for decreasing false alarms.

### BACKGROUND OF THE INVENTION

Electronic article surveillance (“EAS”) systems are detection systems that allow the identification of a marker or tag within a given detection region. EAS systems have many uses, but most often they are used as security systems for preventing shoplifting in stores or removal of property in office buildings. EAS systems come in many different forms and make use of a number of different technologies.

A typical EAS system includes an electronic detection unit, tags and/or markers, and a detacher or deactivator. The detection units can, for example, be formed as pedestal units, buried under floors, mounted on walls, or hung from ceilings. The detection units are usually placed in high traffic areas, such as entrances and exits of stores or office buildings. The tags and/or markers have special characteristics and are specifically designed to be affixed to or embedded in merchandise or other objects sought to be protected. When an active tag passes through a tag detection region, the EAS system sounds an alarm, a light is activated and/or some other suitable alert devices are activated to indicate the removal of the tag from the prescribed area.

Common EAS systems operate with these same general principles using either transceivers, which each transmit and receive, or a separate transmitter and receiver. Typically the transmitter is placed on one side of the detection region and the receiver is placed on the opposite side of the detection region. The transmitter produces a predetermined excitation signal in a tag detection region. In the case of a retail store, this detection region is usually formed at an exit. When an EAS tag enters the detection region, the tag has a characteristic response to the excitation signal, which can be detected. For example, the tag may respond to the signal sent by the transmitter by using a simple semiconductor junction, a tuned circuit composed of an inductor and capacitor, soft magnetic strips or wires, or vibrating magneto acoustic resonators. The receiver subsequently detects this characteristic response. By design, the characteristic response of the tag is distinctive and not likely to be created by natural circumstances.

An important consideration in connection with the use of such EAS systems is to minimize the occurrence of false alarms which could either cause embarrassment to customers of an EAS system user, e.g., a retail store, or produce annoying and disruptive alarm signals when no one is passing through the store's EAS system. There are various types of false alarm signals including a “false” alarm that occurs when a shopper passes through the EAS system, without possessing any tag-bearing or protected merchandise, but an alarm is nevertheless sounded. Yet another, more specific type of false alarm signal is the so-called “merchandise” alarm, which occurs when a shopper carries non-protected merchandise through the EAS system which nevertheless exhibits the characteristics of an active tag. Examples of this are items such as extension cords and cables, foldable chairs, and other coiled metal objects that are capable of resonance in the presence of the electromagnetic field of an EAS system. Another specific type of false alarm signal is the “phantom” alarm, which occurs when an EAS system sounds an alarm responsive to the detection of an “ambient” signal, generally when there is no one passing through the EAS system. Examples of this are false alarm signals produced by tag-bearing merchandise placed on display near enough to the EAS system to accidentally cause an alarm condition or when tag-bearing merchandise is temporarily introduced into the detection region but does not exit the retail space.

What is needed is a method and system that can be used to reduce or eliminate false alarms in EAS system detection regions especially when tag-bearing merchandise does not exit the retail space.

### SUMMARY OF THE INVENTION

In accordance with one aspect, the present invention advantageously provides a method for generating alarms in a security system that includes establishing a detection region, detecting a first event where the first event is one of (a) detecting a tag in the detection region and (b) detecting a person in the detection region, starting a timer upon detecting the first event, detecting a second event where the second event is the other one of (a) detecting a tag in the detection region and (b) detecting a person in the detection region and enabling an alarm output when the second event is detected prior to expiration of the timer.

In accordance with another aspect, the present invention provides a system for detecting tags attached to protected articles, the system includes a transmitter for producing an applied field in a selected region, a receiver for detecting disturbances in the applied field responsive to tags passing through the region, a sensor for detecting a person passing through the selected region, and a processor that operates to set an alarm event upon detecting the disturbances in the applied field, read a people counter event flag, and enable an alarm output when the people counter event flag is set.

In accordance with another aspect, the present invention provides a computer program product including a computer usable medium having a computer readable program for a security system which when executed on a computer causes the computer to perform a method that includes establishing a detection region, detecting a first event where the first event is one of (a) detecting a tag in the detection region and (b) detecting a person in the detection region, starting a timer upon detecting the first event, detecting a second event where the second event is the other one of (a) detecting a tag in the detection region and (b) detecting a person in the detection region and enabling an alarm output when the second event is detected prior to expiration of the timer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an electronic article surveillance system constructed in accordance with the principles of the present invention;

FIG. 2 is a block diagram of an embodiment of an EAS detection unit of the electronic article surveillance system of FIG. 1, constructed in accordance with the principles of the present invention;

FIG. 3 is a flowchart of an exemplary false alarm reduction process in accordance with the principles of the present invention; and

FIG. 4 is a flowchart of another exemplary false alarm reduction process in accordance with the principles of the present invention.

### DETAILED DESCRIPTION OF THE INVENTION

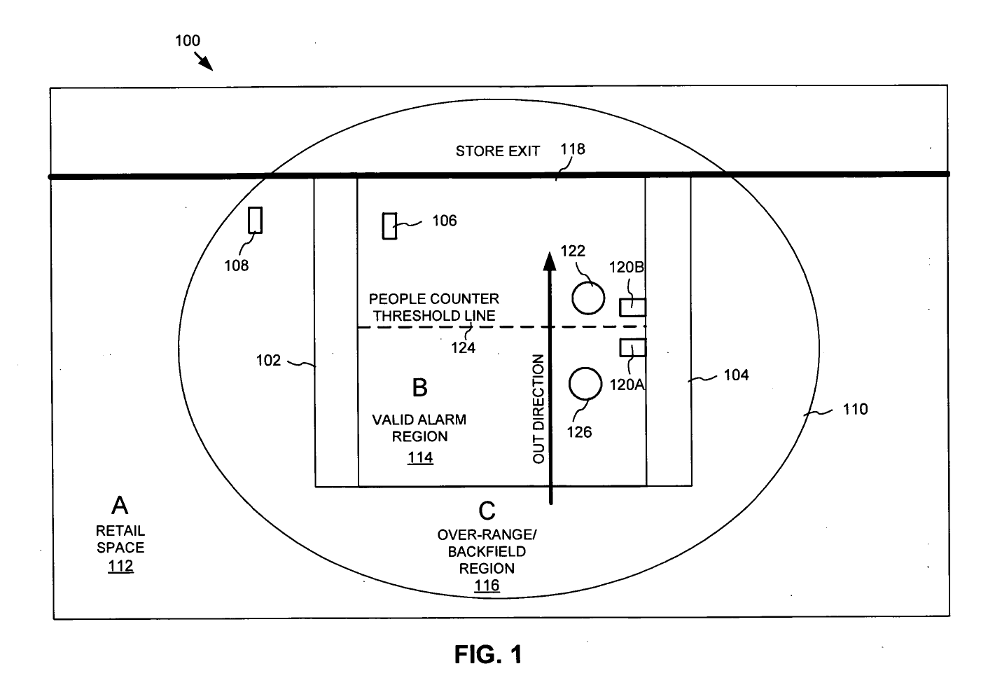

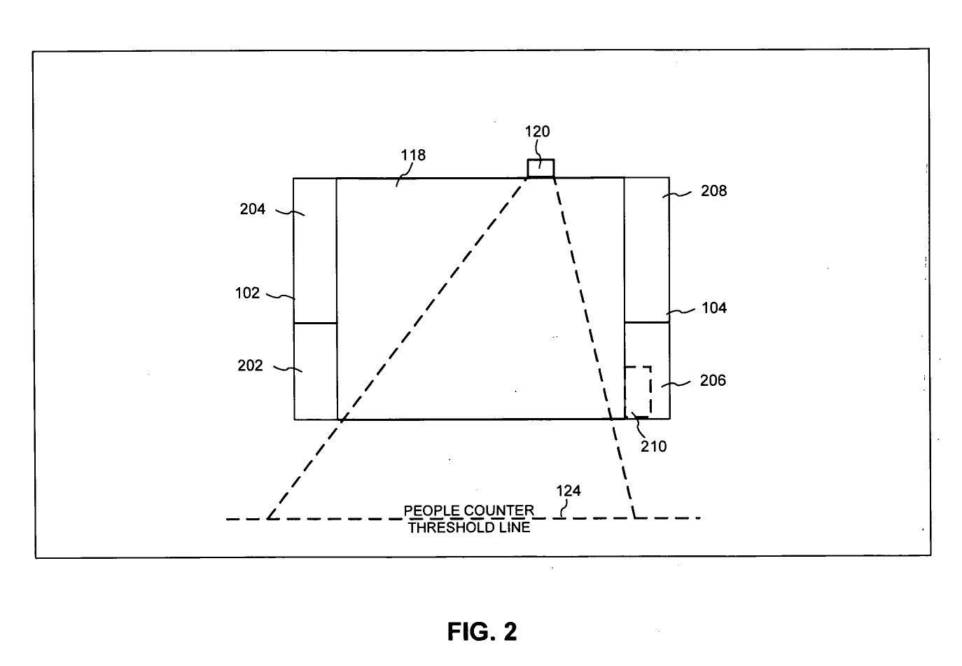

Referring now to the drawing figures in which like reference designators refer to like elements, there is shown in FIG. 1 a diagram of an exemplary system constructed in accordance with the principles of the present invention and designated generally as “100”. Electronic article surveillance (“EAS”) system 100 includes EAS detection units 102, 104 positioned generally in parallel and at a spaced distance from one another. EAS detection unit 102 can include a transmitter 202 (FIG. 2) and a transmitting antenna 204 (FIG. 2) for producing the electromagnetic fields that are used in conjunction with such systems to detect the presence of a tag 106, 108 affixed to merchandise to be protected. The remaining EAS detection unit 104 includes a receiver 206 (FIG. 2) and a receiving antenna 208 (FIG. 2), which then operate to detect a disturbance (resulting from the presence of an active tag 106) in the electromagnetic fields produced by the EAS detection unit 102, which can be used to sound an appropriate alarm. EAS system 100 can create a detection region 110 in retail space 112. Detection region 110 can include valid alarm region 114 and over-range or backfield region 116. A store exit 118 also can be located within detection region 110.

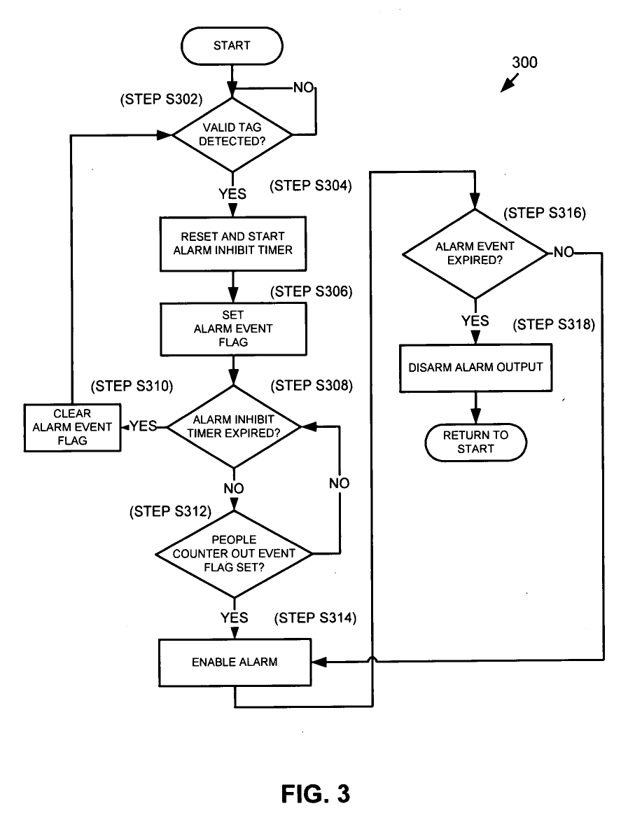

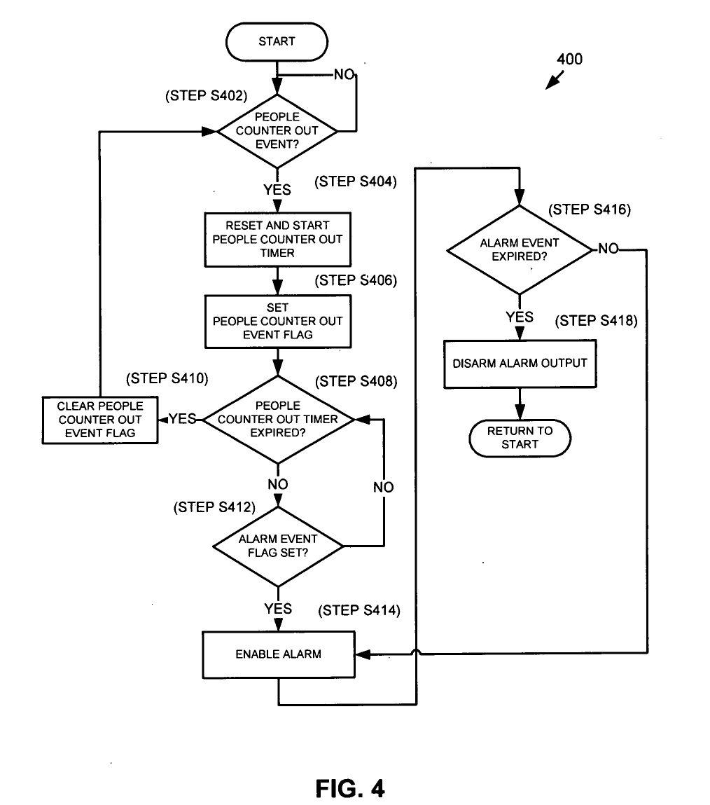

Additionally, one of the EAS detection units 102, 104, preferably the EAS detection unit 104 that includes receiver 206 (FIG. 2), provides a sensor system 120 that includes sensors 120A, 120B (collectively referred to herein as sensor system 120 as used herein) that is capable of detecting the presence of someone exiting or entering the store between the EAS detection units 102, 104 of the EAS system 100. The sensor system 120 is capable of detecting the direction of a person's movement as that person enters or exits the store. A variety of people detection technologies such as sensors that provide a beam can be used for this purpose, e.g., infrared beam sensors, or other people detection sensors such as photoelectric sensors, body heat sensors, and even floor switches, as desired. These sensors can be deployed at various locations of EAS system 100. For example, sensor system 120 can be deployed in EAS detection units 102, 104, building posts, door frames and/or ceilings. Whatever the case may be, the sensor system 120 is electrically connected to the receiver 206 (FIG. 2) of the EAS system 100 so that the EAS system 100 can be informed when a person 122, e.g., a shopper, passes between the EAS detection units 102, 104 and crosses a people counter threshold line 124 in detection region 110 in an “out” direction. In FIG. 1, person 122 is shown located in valid alarm region 114 at a point past the people counter threshold line 124 while person 126 is shown located in valid alarm region 114 at a point prior to the people counter threshold line 124. In operation, as discussed in more detail with reference to FIGS. 3 and 4 below, person 122 generates a “people counter out” event because person 122 has crossed threshold line 124 in the out direction and triggered a people counter event. On the other hand, person 126 does not generate a “people counter out” event because person 126 has not crossed threshold line 124 or has crossed the threshold line 124 in the “in” direction which does not trigger the people counter out event. This advantageously avoids false alarms that are typically generated by a person re-entering the store with tagged merchandise.

In another embodiment, a single EAS detection unit 102 is supplied that uses a transceiver 202 (FIG. 2) and a transceiver antenna 204 (FIG. 2) to produce detection region 110 by producing the electromagnetic fields that are used to detect the presence of a tag 106, 108 affixed to merchandise to be protected. In this embodiment, transceiver 202 and transceiver antenna 204 also function to receive a disturbance in the produced electromagnetic field of EAS detection unit 102. For example, although FIG. 2 shows EAS detection unit 102 deployed in a pedestal, the transceiver 202 and/or the transceiver antenna 204 or both can be deployed on a door that is located at a store exit 118. In this embodiment, transceiver antenna 204 radiates the appropriate electromagnetic or radio frequency field to produce the detection region 110.

The processing of data and signals developed by the EAS detection units 102, 104 of the EAS system 100, as well as interaction with the sensor system 120, is accomplished by a processor 210 associated with the EAS system 100, that can be generally positioned within the transceivers/receivers 202, 206. The processor 210 is used to analyze signals detected by the receiver 206 to detect the presence of a tag 106 between the EAS detection units 102, 104 of the EAS system 100, and detection data generated by the sensor system 120 based on the detection of a person. Processor 210 executes instructions and manipulates data to perform the operations of EAS system 100 and may be, for example, a central processing unit (“CPU”), an application specific integrated circuit (“ASIC”) or a field-programmable gate array (“FPGA”). Processor 210 also controls various registers and counters such as alarm event and people counter event registers and alarm inhibit and people counter timers, each of which relates to the operation of EAS system 100. These registers and timers can be located in processor 210 or in other memory of EAS system 100 that is in communication with processor 210. Although FIG. 1 illustrates a single processor 210 in EAS system 100, multiple processors 210 may be used according to particular needs, and reference to processor 210 is meant to include multiple processors 210 where applicable. In certain embodiments, processor 210 executes one or more processes associated with EAS applications.

Referring again to FIG. 2, a motion detector or people sensor 120 is illustrated mounted near the top of a store exit/entrance that is defined by EAS units 102, 104 that are integrated into two pillars or support columns. In this embodiment, sensor 120 is an infrared beam sensor, which defines the people counter threshold line 124. People counter threshold line 124 serves as an event trigger point to notify processor 210 to produce an event when a person crosses the people counter threshold line 124 in the “out” direction. The present invention further provides a means to determine the movement of any tags 106, 108 or people 122, 126 within detection region 110 via EAS units 102, 104 and/or sensor system 120. For example, as a tag enters over-range region 116, it disrupts the detection field and will typically transmit a “reradiated” signal to a transceiver/receiver of EAS units 102, 104. The reradiated signal can have a level of signal strength that is determinable by EAS units 102, 104. Similar to measuring a received signal strength indication (“RSSI”) of other radio frequency signals, the reradiated signal of the tag can be measured. Alternatively, multiple sensors, e.g., 120A and 120B, of sensor system 120 can create one or more people counting threshold lines or points 124. As a person or object crosses each threshold line, an event signal is generated and processed by the processor 210 to determine the relative direction of the person.

FIG. 3 is a flow chart illustrating an exemplary method 300 for minimizing false alarms in EAS system 100 using a sensor system 120. Exemplary method 300 is discussed with reference to EAS system 100, however, any other suitable system or portion of a system may use appropriate embodiments of method 300 to retrieve and process EAS information to manage the security of tag bearing merchandise in an EAS detection region 110. Generally, method 300 describes an active tag 106 entering a detection region 110 and arming an alarm but not activating the alarm unless and until certain conditions are satisfied, such as the detection of the presence of someone between EAS detection units 102, 104 of EAS system 100 who has crossed threshold line 124 in the “out” direction.

Exemplary method 300 begins at step S302, when a determination is made as to whether a first event is detected, such as whether a valid active tag 106 or 108 is detected within detection region 110 or a person 122 passes or crosses a people counting threshold line or point 124 in the “out” direction. In the illustrative example of FIG. 1, tag 106 is shown in a valid alarm region 114 of detection region 110, while tag 108 is shown in the over-range region 116 of detection region 110. For example, tag 108 can be attached to an object that is positioned on a retail shelf that is permanently located in the over-range region 116. In this case, EAS system 100 can identify tag 108 as an invalid tag because tag 108 is detected continuously so as to create a seemingly permanent alarm “armed” condition. This permanent alarm “armed” condition will typically be detected upon EAS system 100 activation and therefore, EAS system 100 will notify a system manager of this condition through some visual or audible indicator, e.g., a LED, by way of one of the EAS detection units 102, 104 or a control panel display having a graphical user interface (“GUI”) or the like, which is integrated or in communication with EAS system 100. If tag 108 is identified as an invalid tag, then it cannot satisfy the first inquiry at step S302. If no valid tag is detected, then step S302 is repeated until a valid tag is detected such as tag 106 that causes an event timer, e.g., an alarm inhibit timer or a “people counter out” timer to be reset or cleared and then started at step S304.

At step S306, an event flag is set such as an alarm event flag or a people counter out event flag, which causes an EAS system alarm to arm but not activate. Next, the event timer such as alarm inhibit timer is accessed or read to determine whether the event timer has expired (step S308). If the alarm inhibit timer has expired, the alarm event flag is cleared (step S310), and the process returns to step S302 for detecting the next event, e.g., the next valid tag. Otherwise, a second event flag, e.g., people counter out event flag, is examined to determine if this flag is set (valid). The people counter out event flag is set upon the occurrence of a people counter out event. A people counter out event occurs when any person in valid alarm region 114 passes (in the “out” direction) through a people counter threshold line or point 124 located between the EAS detection units 102, 104 (step S312). If the people counter out event flag is not set, the process returns to step S308 to check the status of alarm inhibit timer. Alarm inhibit timer is a timer that provides a time period or window in which a preconditioned event can occur so that the detected alarm event is determined to be a valid alarm event. If the preconditioned event does not occur before the inhibit timer expires, processor 210 determines that the alarm event is invalid, and clears the alarm event flag thereby inhibiting the generation of an alarm output signal. Otherwise, if the people counter out event flag is set, then the alarm output is enabled to indicate a valid alarm at step S314.

At step S316, the expiration of the alarm event is checked and if the alarm event has not expired, the alarm output remains enabled (step S314). Otherwise, at step S318, the alarm output is terminated and the process returns to the start of method 300.

FIG. 4 is a flow chart illustrating an exemplary method 400 for minimizing false alarms in EAS system 100 using a sensor system 120. Exemplary method 400 is discussed with reference to EAS system 100, however, any other suitable system or portion of a system may use appropriate embodiments of method 400 to retrieve and process EAS information to manage the security of tag bearing merchandise in an EAS detection region 110. Generally, method 400 describes a person entering a detection region 110 and passing through a people counter threshold line or point 124 in the “out” direction to arm an alarm but not activate the alarm unless and until certain conditions are satisfied, such as the detection of a valid tag in valid alarm region 114 of detection region 110.

Exemplary method 400 begins at step S402, when a determination is made as to whether a people counter out event has occurred within detection region 110. As described in the exemplary method 300 of FIG. 3, a people counter out event occurs when any person in valid alarm region 114 passes (in the “out” direction) through a people counter threshold line or point 124 located between the EAS detection units 102, 104. In the illustrative example of FIG. 1, persons 122, 126 are shown in a valid alarm region 114 of detection region 110. However, person 126 is shown located prior to the people counter threshold line, while person 122 is shown having crossed the people counter threshold line in the “out” direction. In this case, person 122 causes a people counter out event to occur which cause a people counter out timer to be reset or cleared and then started at step S404. If no people counter out events are detected, then step S402 is repeated until a people counter out event occurs.

At step S406, a people counter out event flag is set causing an EAS system alarm to arm but not activate. Next, the people counter out timer is accessed or read to determine whether the timer has expired (step S408). If the people counter out timer has expired, the people counter out event flag is cleared (step S410), and the process returns to step S402 for detecting the next people counter out event. Otherwise, an alarm event flag is examined to determine if this flag is set. The alarm event flag is set upon the detection of a valid tag in valid alarm region 114 of detection region 110 (step S412). If the alarm event flag is not set, the process returns to step S408 to check the status of the people counter out timer. People counter out timer is a timer that provides a time period or window in which a preconditioned event can occur so that the detected people counter out event is determined to cause a valid alarm event. If the preconditioned event does not occur before the people counter out timer expires, processor 210 determines that the alarm event is invalid, and clears the people counter out event flag thereby inhibiting the generation of an alarm output signal. Otherwise, if the alarm event flag is set, then the alarm output is enabled to indicate a valid alarm at step S414.

At step S416, the expiration of the alarm event is checked and if the alarm event has not expired, the alarm output remains enabled (step S414). Otherwise, at step S418, the alarm output is terminated and the process returns to the start of method 400.

The present invention advantageously provides and defines a comprehensive system and method for detecting tags attached to items in electronic article surveillance systems. The present invention further advantageously provides and defines a comprehensive system and method for reducing false alarms in an EAS system using people detection technologies such as infrared beam sensors.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. A variety of modifications and variations are possible in light of the above teachings without departing from the spirit or essential attributes thereof, and accordingly, reference should be had to the following claims, rather than to the foregoing specification, as indicating the scope of the of the invention.

What is claimed is:

1. A method for generating alarms in a security system, the method comprising:
establishing a detection region;
detecting a first event, the first event being one of (a) detecting a tag in the detection region and (b) detecting a person in the detection region;
starting a timer upon detecting the first event;
detecting a second event, the second event being the other one of (a) detecting a tag in the detection region and (b) detecting a person in the detection region; and
enabling an alarm output when the second event is detected prior to the expiration of the timer.

2. The method of claim 1, wherein detecting a person in the detection region includes determining the relative direction of movement of the person.

3. The method of claim 1, further comprising setting a first event flag upon detecting the first event, the first event flag corresponding to the first event.

4. The method of claim 1, further comprising setting a second event flag upon detecting the second event, the second event flag corresponding to the second event.

5. The method of claim 1, further comprising incrementing the timer during an event wait period.

6. The method of claim 1, wherein setting a first event flag includes setting a people counter event when a person is detected crossing a people counter threshold line in the detection region.

7. The method of claim 6, wherein the people counter threshold line is generated using a people detection sensor.

8. The method of claim 7, wherein the people detection sensor is an infrared beam sensor.

9. The method of claim 1, wherein establishing a detection region includes establishing an applied field.

10. The method of claim 9, further comprising detecting disturbances in the applied field responsive to tags passing through the detection region.

11. A system for generating alarms, the system comprising:
a transmitter for producing an applied field in a selected region;
a receiver for detecting disturbances in the applied field responsive to tags passing through the region;
a sensor for detecting a person passing through the selected region; and
a processor, the processor operating to:
detect a first event, the first event being one of (a) detecting a tag in the detection region and (b) detecting a person in the detection region;
start a timer upon detecting the alarm event;
detect a second event, the second event being the other one of (a) detecting a tag in the detection region and (b) detecting a person in the detection region; and
enable an alarm output when the second event is detected prior to expiration of the timer.

12. The system of claim 11, wherein detecting a person in the detection region includes determining the relative direction of movement of the person.

13. The system of claim 11, wherein the processor further operates to set a first event flag upon detecting the first event, the first event flag being one of (a) an alarm event flag and (b) a people counter event flag.

14. The system of claim 13, wherein the processor further operates to set a second event flag upon detecting the second event, the second event flag being the other one of (a) an alarm event flag and (b) a people counter event flag.

15. The system of claim 11, wherein the processor further operates to enable an alarm output conditioned upon the alarm inhibit timer remaining valid.

16. The system of claim 11, wherein the processor further operates to set a people counter event when a person is detected crossing a people counter threshold line in the out direction of the detection region.

17. The system of claim 16, wherein the people counter threshold line is generated using a people detection sensor.

18. A computer program product comprising a computer usable medium having a computer readable program for a security system which when executed on a computer causes the computer to perform a method comprising:
establishing a detection region;
detecting a first event, the first event being one of (a) detecting a tag in the detection region and (b) detecting a person in the detection region;
starting a timer upon detecting the first event;
detecting a second event, the second event being the other one of (a) detecting a tag in the detection region and (b) detecting a person in the detection region; and
enabling an alarm output when the second event is detected prior to the expiration of the timer.

19. The method of claim 18, wherein setting a timer upon detecting the first event includes incrementing the timer during an event wait period.

20. The method of claim 18, further comprising setting a first event flag upon detecting the first event, the first event flag being one of (a) an alarm event flag and (b) a people counter event flag.
